(19) United States
(12) Patent Application Publication
(10) Pub. No.: US 2015/0053048 A1
(43) Pub. Date: Feb. 26, 2015

(54) METAL JOINING COMPONENT AND METHOD FOR IMPROVED RECYCLING

(71) Applicant: Joseph W. Harris, Cincinnati, OH (US)

(72) Inventor: Joseph W. Harris, Cincinnati, OH (US)

(21) Appl. No.: 13/975,891

(22) Filed: Aug. 26, 2013

(51) Int. Cl. B23K 35/24; B23K 35/40; B23K 35/02

(52) U.S. Cl. CPC B23K 35/24; B23K 35/0227; B23K 35/0261; B23K 35/40
USPC 75/302; 72/362

(57) ABSTRACT

A consumable metal joining component having identification for improved recycling has an elongated element formed from a filler metal alloy with a predetermined alloying characteristic. The elongated element has a pair of end portions and an intermediate portion extending therebetween. Each of the end portions has a compositional indicium indicative of the predetermined alloying characteristic. One of the pair of end portions and the intermediate portion of the elongated element are configured to be consumed by heat in a metal joining process. As such, the other of the pair of end portions with the respective compositional indicium remains intact to enable recycling of the remaining end portion regardless of which end portion is consumed.

### TECHNICAL FIELD

The present invention relates generally to a metal joining component for connecting metals, such as in brazing, welding, or soldering.

### BACKGROUND

Consumable metal joining components, such as rods and wires, are well known for connecting base metals. Traditional processes for connecting base metals with the aid of consumable filler metal melted from the rod or wire include welding, brazing, and soldering. These processes generally differ based on temperature and whether or not a base metal melts in addition to the filler metal for connecting the metals. Accordingly, a wide variety of filler metal alloys with differing compositions have been developed for use in welding, brazing, and soldering for compatibility with the various base metals and to achieve specific material properties in the final connection of the base metal and the filler metal.

By way of example, phosphorus-copper (phos-copper) alloys, identified by the American Welding Society (AWS) classification BCuP 1-9 brazing alloys (hereinafter “BCuP brazing alloys”), have been in wide use to join copper tubing and copper alloys together for over the past 70 years. Phos-copper alloys that further include silver may also be referred to as phos-copper-silver alloys. Because these brazing alloys make strong ductile joints that resist vibration stresses, they are in wide use for the manufacture, installation and repair of air conditioning and refrigeration systems. Phosphorus and silver are used in the BCuP brazing alloys primarily to reduce brazing temperatures. Phosphorus also provides a self-fluxing property to the BCuP alloys when used to braze copper. The silver content typically ranges from 0% to 18% by weight, while the phosphorus content is typically 4-7.5%. In contrast, carbon and low alloy steel, cast iron, stainless steel and nickel metals are generally brazed with AWS classification BAg 1-39 silver brazing filler metals. The BAg brazing alloys comprise silver, copper, zinc and may also include nickel and/or tin. The silver content ranges from 24-93% by weight, with 35-56% being most common. Zinc content ranges from 4-35% by weight, with 13-30% being most common.

During use, a power source, such as an electric or fuel supply, heats the rod or wire to a melting point regardless of the process or filler metal used. An operator selects an end portion of the rod or wire to grip, otherwise referred to herein as a terminal end, and then begins melting the other end portion of the rod, otherwise referred to herein as an initial end portion. The operator may select either end portion, because the rod or wire is generally formed from a uniform alloy along the entirety of the rod or wire. Typically, the heat melts the rod or wire at the initial end portion allowing it to flow into the joint between the base metals and effectively consumes that end portion of the rod or wire while the operator continues to grip the opposing, terminal end portion. The consumption of the rod or wire then continues from the initial end portion, along an intermediate portion, and toward the terminal end portion until only the terminal end portion remains. Due to the position of the operator's grip, the terminal end portion is not available for consumption and must be discarded. Alternatively, the terminal end portion can be brazed to a new rod or wire in an attempt to avoid waste, but the effort is generally more costly (in time, for example) than the worth of the end portion, also commonly referred to as a stub.

Despite not being useable for welding, brazing, or soldering, the remaining end portion or stub may be conserved and recycled for monetary value. The operator may collect many end portions over time for recycling that have any variety of metal compositions, such as those discussed above. However, recycling the end portions requires that the end portions first be sorted by the type of alloy composition, and/or by the amount of a particular alloying element. For example, end portions having a silver content of 15% should be separated and sorted together, whereas end portions having a silver content of 10% should be likewise separated and sorted together. Sorting end portions of unknown alloy composition is both time consuming and costly. For this reason, many in the industry choose not to recycle the remaining end portions of rods or wires and, in turn, create additional waste and lost value.

There is a need for a metal joining component and method for improved recycling of a remaining end portion that address present challenges and characteristics such as those discussed above.

### SUMMARY

According to an exemplary embodiment, a consumable metal joining component having identification for improved recycling has an elongated element formed from a filler metal alloy. The filler metal alloy has a predetermined alloying characteristic. The elongated element has a pair of end portions and an intermediate portion extending therebetween. Each of the pair of end portions has a compositional indicium indicative of the predetermined alloying characteristic. One of the end portions and the intermediate portion of the elongated element are configured to be consumed by heat in a metal joining process. As such, the other of the pair of end portions with the respective compositional indicium remains intact to enable recycling of the remaining one of the pair of end portions regardless of which end portion is consumed.

Another exemplary embodiment of a consumable metal joining component having identification for improved recycling has an elongated element formed from a brazing metal alloy. The brazing metal alloy has a predetermined alloying characteristic. The elongated element has a first end portion, a second end portion, and an intermediate portion extending therebetween. In addition, a first numerical compositional indicium and a second numerical compositional indicium are respectively positioned on the first and second end portions. The intermediate portion and one of the first or second end portions of the elongated element are configured to be consumed by heat in a brazing process that starts from one of the first or second end portions and ceases when the intermediate portion is consumed. Accordingly, the other one of the second or first end portions and respective second or first numerical compositional indicia remain unbrazed to enable recycling of the remaining second or first end portion regardless of which one of the first or second end portions is consumed.

An exemplary end portion of a consumable metal joining component having identification for improved recycling is manufactured by selecting a consumable metal alloy having a predetermined alloying characteristic. The method further includes forming the consumable metal alloy into an elongated element having a pair of end portion and an intermediate portion extending therebetween and marking each end portion with a compositional indicium indicative of the predetermined alloying characteristic.

Various additional objectives, advantages, and features of the invention will be appreciated from a review of the following detailed description of the illustrative embodiments taken in conjunction with the accompanying drawings.

### BRIEF DESCRIPTION OF THE DRAWINGS

The accompanying drawings, which are incorporated in and constitute a part of this specification, illustrate embodiments of the invention and, together with a general description of the invention given above, and the detailed description given below serve to explain the invention.

FIG. 1A is a perspective view of a metal joining component having a compositional indicium according to embodiments of the invention.

FIG. 1B is an end view of the metal joining component of FIG. 1A.

FIG. 2 is a perspective view of a remaining end portion of a metal joining component after use in a metal joining process according to embodiments of the invention.

### DETAILED DESCRIPTION

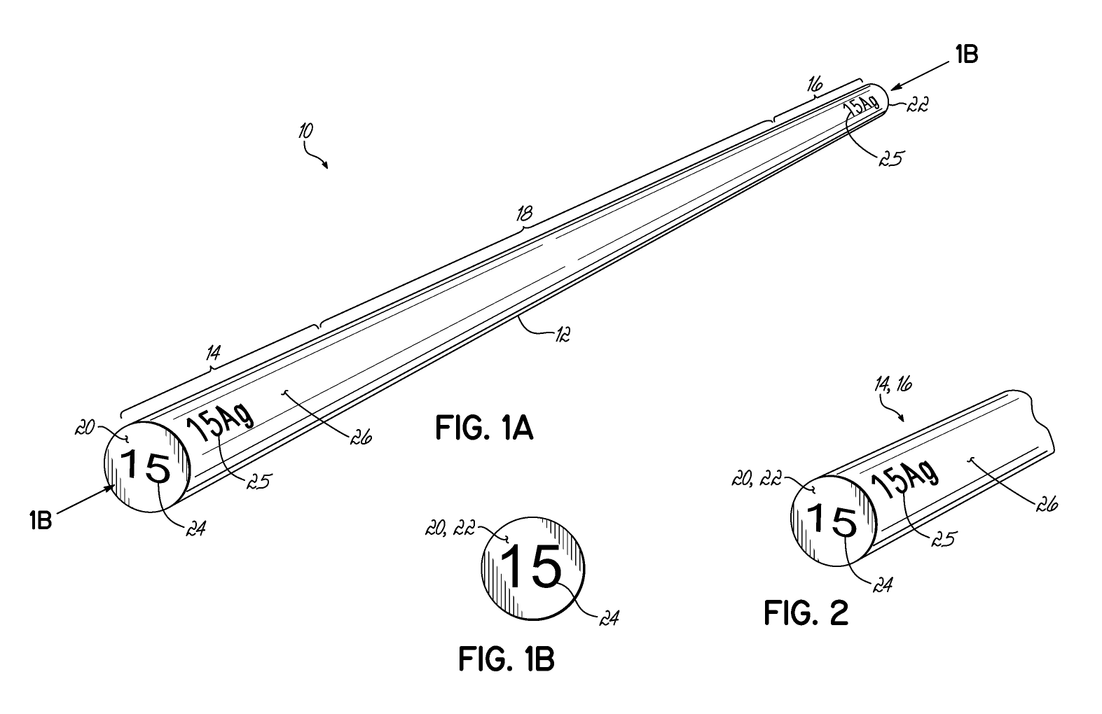

With reference to FIG. 1A, an embodiment of a consumable metal joining component 10 in the form of an elongated element 12 is formed from a filler metal alloy for use in a metal joining process, such as welding, brazing, or soldering. While the elongated element 12 is shown as a rod having a cylindrical shape, it will be appreciated that the elongated element 10 may alternatively be a wire (coiled or uncoiled) or another other shape that may be used in the metal joining process. The elongated element 12 has a first end portion 14, a second end portion 16, and an intermediate portion 18 extending between the first and second end portions 14, 16. While FIG. 1A shows an exemplary embodiment of the approximate locations of the portions 14, 16, 18, it will be appreciated that the lengths of these portions 14, 16, 18 may vary as is well understood in the art. As such, the approximate length of each portion 14, 16, and 18 is merely illustrative and not intended to limit the invention described herein.

The first and second end portions 14, 16 also have first and second end faces 20, 22, respectively. In accordance with one embodiment, each of the first and second end faces 20, 22 are marked with a compositional indicium 24 indicative of a predetermined alloying characteristic for use in the metal joining process. According to an exemplary embodiment, the compositional indicium 24 is a numerical compositional indicium marked onto the first and second end faces 20, 22 that represents a percentage of an alloy component within the filler metal alloy. For example, the numerical compositional indicium is a “15” and indicates that the filler metal alloy contains 15% silver. However, it will be appreciated that any indicium, such as a color, image, or text may convey similar information to an operator. Similarly, each compositional indicium 24 on each end face 20, 22 is identical; however, it will be appreciated that the compositional indicium 24 on the first face 20 may alternatively vary from the compositional indicium 24 on the second face 22. For example, the first end face 20 may have the numerical compositional indicium 24, whereas the second end face 22 may have an image compositional indicium. In any case, each of the end faces 20, 22 includes a form of the compositional indicium 24 for indicating the predetermined alloying characteristic.

In another embodiment, also shown in FIG. 1A, a compositional indicium 25 is marked on a surface 26 of the elongated element 12 in each of the first and second end portions 14, 16. Marking the surface 26 rather than the end faces 20, 22 may provide more surface area to fit the needed compositional indicium 25, particularly if it includes the percentage and element symbol, as shown. Of course, only one of the compositional indicia 24 or 25 need be used, so long as both end portions 14, 16 are marked, but combinations may be used, such as a color indicium on the end faces 20, 22 and a numerical indicium on the surface 26.

The filler metal alloy is configured to be consumed by heat during the metal joining process. As such, the first end portion 14, the second end portion 16, and intermediate portion 18 are all configured to be consumed by heat. Because the entirety of the elongated element 12 is uniformly formed from the filler metal alloy, the operator may select either the first end portion 14 or the second end portion 16 to serve as the initial end portion to be melted. In turn, the operator similarly selects the other second end portion 16 or the first end portion 14 to grip and serve as the terminal end portion. According to an exemplary embodiment shown in FIG. 1A, the filler metal alloy is a brazing metal alloy. More particularly, the brazing metal alloy is a copper-phosphorus alloy having the predetermined alloying characteristic of 15% silver by weight, hence the numerical compositional indicium 24 being “15” as shown in FIGS. 1A, 1B and 2, and the compositional indicium 25 being “15Ag” as shown in FIGS. 1A and 2.

In order to manufacture the metal joining component 10, a manufacturer selects the consumable metal alloy having the predetermined alloying characteristic. The consumable metal alloy is then formed into the elongated element 12 described above. According to an exemplary embodiment, the manufacturer marks first and second end portions 14, 16 by stamping the compositional indicia 24 or 25 on the first and second end faces 20, 22 or surface 26, respectively. However, it will be appreciated that other known manufacturing methods of marking the first and second end portion 14, 16 may be used in conjunction with stamping or as an alternative to stamping. For example, laser etching, chemical etching or reaction, or plating methods may be used.

During the metal joining process, the consumption of the elongated element 12 continues from the initial end portion, which may be either the first or second end portion 14, 16, along the intermediate portion 18, and toward the terminal end portion, which may be either the second or first end portion 16, 14, respectively. As may be understood to persons of ordinary skill in the art, the consumption may occur in a single operation, or the same metal joining component 10 may be used for more than one operation, in which case the process is always resumed by heating the same end as previously heated. Once the intermediate portion 18 is consumed as shown in FIG. 2, the operator may view the compositional indicium 24 or 25 on the remaining first or second end portion 14, 16 for an understanding of the predetermined alloying characteristic. Again, because both first and second end portions 14, 16 are marked with the compositional indicium 24 or 25, one of the compositional indicia will always remain on the remaining first or second end portion 14, 16 regardless of which end portion 14, 16 was initially consumed. Finally, with the predetermined alloying characteristic known, the operator or a recycler is able to quickly and efficiently sort the remaining end portion 14, 16 for recycling and may save the remaining end portion 14, 16 accordingly.

As described herein, a consumable metal joining component having identification for improved recycling has an elongated element formed from a filler metal alloy. The filler metal alloy has a predetermined alloying characteristic. The elongated element has a pair of end portions and an intermediate portion extending therebetween. Each of the pair of end portions has a compositional indicium indicative of the predetermined alloying characteristic. One of the pair of end portions and the intermediate portion of the elongated element are configured to be consumed by heat in a metal joining process. As such, the other of the pair of end portions with the respective compositional indicium remains intact to enable recycling of the remaining one of the pair of end portions regardless of which end portion is consumed.

In one aspect, the compositional indicium on one of the pair of end portions may be generally identical in appearance to the compositional indicium on the other of the pair of end portions. Also, the compositional indicium may include a numerical compositional indicium representative of the predetermined alloying characteristic. More particularly, the predetermined alloying characteristic may be a percentage of an alloying element, such as silver, within the filler metal alloy. The percentage may also be combined with the symbol for that element, such as “Ag” for silver.

In one embodiment, each of the pair of end portions of the elongated element has an end face, and each compositional indicium is positioned on the pair of end faces, respectively. In another embodiment, the elongated element has a surface along its length, and the compositional indicium is positioned on the surface at each end portion. According to an exemplary embodiment, the elongated element is a rod or wire. More particularly, the filler metal alloy is a brazing metal alloy, such as a copper-phosphorus alloy and the predetermined alloying characteristic is silver content.

As further described herein, a brazing metal joining component having identification for improved recycling has an elongated element formed from a brazing metal alloy. The brazing metal alloy has a predetermined alloying characteristic. The elongated element has a first end portion, a second end portion, and an intermediate portion extending therebetween. In addition, a first numerical compositional indicium and a second numerical compositional indicium are respectively positioned on the first and second end portions. The intermediate portion and one of the first or second end portions of the elongated element are configured to be consumed by heat in a brazing process that starts from one of the first or second end portions and ceases when the intermediate portion is consumed. Accordingly, the other one of the second or first end portions and respective second or first numerical compositional indicia remain unbrazed to enable recycling of the remaining second or first end portion regardless of which one of the first or second end portions is consumed.

In one aspect, the predetermined alloying characteristic may be a percentage of an alloying element, such as silver, within the brazing metal alloy, with or without the elemental symbol.

In another aspect, the first and second end portions of the elongated element have a first and second end face, respectively. The first and second numerical compositional indicium are positioned respectively on the first and second end face. In another embodiment, the elongated element has a surface along its length, and the numerical compositional indicium is positioned on the surface at each end portion. According to an exemplary embodiment, the elongated element is a rod or wire. More particularly, the brazing metal alloy is copper-phosphorus alloy and the predetermined alloying characteristic is silver content.

An exemplary embodiment of a method of manufacturing an end portion of a consumable metal joining component having identification for improved recycling described herein includes selecting a consumable metal alloy having a predetermined alloying characteristic and forming the consumable metal alloy into an elongated element having a pair of end portions and an intermediate portion extending therebetween. The method also includes marking each end portion with a compositional indicium indicative of the predetermined alloying characteristic.

In one aspect, the method may include stamping each end portion with the compositional indicium.

In one embodiment, the brazing metal alloy is a copper-phosphorus alloy, which alloys are known to persons of ordinary skill in the art to be notch-sensitive. If the rod or wire is bent during a brazing operation in an area in which a raised or indented compositional indicium is placed, the rod or wire may snap or break. By limiting the compositional indicium to the end portions of the rod or wire, such as within a two-inch area at the ends, and leaving the intermediate portion indicium-free, breakage from notch-sensitivity can be eliminated, as the rod or wire is typically not bent by the brazing operator within those end portions.

The present invention fills a need in the metal joining industries, and the brazing industry in particular. Approximately 13-15% of the value of a brazing rod or wire, for example, is wasted due to a lack of means for recycling the unbrazed terminal end portion or stub. By virtue of the invention, the stubs can be collected and returned to a manufacturer or designated recycler for salvaging the valuable alloys or alloy components, and a rebate can be earned, thereby recouping some or all of that otherwise wasted 13-15% value.

While the present invention has been illustrated by the description of one or more embodiments thereof, and while the embodiments have been described in considerable detail, they are not intended to restrict or in any way limit the scope of the appended claims to such detail. The various features shown and described herein may be used alone or in any combination. Additional advantages and modifications will readily appear to those skilled in the art. The invention in its broader aspects is therefore not limited to the specific details, representative apparatus and method and illustrative examples shown and described. Accordingly, departures may be from such details without departing from the scope of the general inventive concept.

What is claimed is:

1. A consumable metal joining component having identification for improved recycling, comprising;
an elongated element formed from a filler metal alloy having a predetermined alloying characteristic, the elongated element having a pair of end portions and an intermediate portion extending therebetween, each of the pair of end portions having a compositional indicium indicative of the predetermined alloying characteristic,
wherein one of the pair of end portions and the intermediate portion of the elongated element are configured to be consumed by heat in a metal joining process such that the other of the pair of end portions with the respective compositional indicium remains intact to enable recycling of the remaining one of the pair of end portions regardless of which one of the pair of end portions is consumed.

2. The consumable metal joining component of claim 1 wherein the compositional indicium on one of the pair of end portions is generally identical in appearance to the compositional indicium on the other of the pair of end portions.

3. The consumable metal joining component of claim 1 wherein the compositional indicium is a numerical compositional indicium representative of the predetermined alloying characteristic.

4. The consumable metal joining component of claim 3 wherein the predetermined alloying characteristic is a percentage of an alloying element within the filler metal alloy.

5. The consumable metal joining component of claim 4 wherein the alloying element is silver.

6. The consumable metal joining component of claim 1 wherein each of the pair of end portions has an end face, and each compositional indicium is positioned on the respective end face.

7. The consumable metal joining component of claim 1 wherein the elongated element is a rod.

8. The consumable metal joining component of claim 1 wherein the filler metal alloy is a brazing metal alloy.

9. The consumable metal joining component of claim 8 wherein the brazing metal alloy is a copper-phosphorus alloy and the predetermined alloying characteristic is silver content.

10. The consumable metal joining component of claim 1 wherein the elongated element has an outer surface, and the first and second compositional indicia are stamped on the outer surface in the respective first and second end portions.

11. A brazing component for improved recycling, comprising;
an elongated element formed from a brazing metal alloy having a predetermined alloying characteristic, the elongated element having a first end portion, a second end portion, and an intermediate portion extending therebetween,
a first numerical compositional indicium positioned on the first end portion; and
a second numerical compositional indicium positioned on the second end portion,
wherein the first and second numerical compositional indicia are generally identical in appearance and representative of the predetermined alloying characteristic, and
wherein the intermediate portion and one of the first or second end portions of the elongated element are configured to be consumed by heat in a brazing process that starts from one of the first or second end portions and ceases when the intermediate portion is consumed such that the other one of the second or first end portions and respective second or first numerical compositional indicia remain unbrazed to enable recycling of the remaining second or first end portion regardless of which one of the first or second end portions is consumed.

12. The brazing component of claim 11 wherein the predetermined alloying characteristic is a percentage of an alloying element within the brazing metal alloy.

13. The brazing component of claim 12 wherein the alloying element is silver.

14. The brazing component of claim 11 wherein the first end portion has a first end face and the second end portion has a second end face, and the first and second numerical compositional indicia are positioned respectively on the first and second end faces.

15. The brazing component of claim 11 wherein the elongated element is a rod.

16. The brazing component of claim 11 wherein the brazing metal alloy is a copper-phosphorus alloy and the predetermined alloying characteristic is silver content.

17. The brazing component of claim 11 wherein the elongated element has an outer surface, and the first and second numerical compositional indicia are stamped on the outer surface in the respective first and second end portions.

18. A method of manufacturing a consumable metal joining component having identification for improved recycling, comprising;
selecting a consumable metal alloy having a predetermined alloying characteristic;
forming the consumable metal alloy into an elongated element having a pair of end portions and an intermediate portion extending therebetween; and
marking each end portion with a compositional indicium indicative of the predetermined alloying characteristic.

19. The method of claim 18 wherein marking each end portion further comprises:
stamping each end portion with the compositional indicium.
